(19) United States
(12) Patent Application Publication
(10) Pub. No.: US 2026/0017610 A1
(43) Pub. Date: Jan. 15, 2026

(54) Vison-Based Autonomous Inventory Management

(71) Applicant: Owens & Minor, Inc., Glen Allen, VA (US)

(72) Inventors: John Heeley, Mechanicsville, VA (US); Selena Culpepper, Mechanicsville, VA (US); Eric Stakem, Mechanicsville, VA (US); David Deboer, Mechanicsville, VA (US)

(21) Appl. No.: 19/266,263

(22) Filed: Jul. 11, 2025

Related U.S. Application Data
(60) Provisional application No. 63/669,900, filed on Jul. 11, 2024.

(51) Int. Cl. G06Q 10/087; G06V 10/70; G06V 20/52; G06V 40/16

(52) U.S. Cl. CPC G06Q 10/0877; G06Q 10/08724; G06V 10/70; G06V 20/52; G06V 40/161; G06V 40/172

(57) ABSTRACT

One or more first images depicting removal of a first inventory item of a plurality of inventory items of a particular item type from an inventory storage area are obtained. The one or more first images are processed with one or more machine-learned computer vision models to generate one or more model outputs. The one or more model outputs identify an item type for the inventory item. The one or more model outputs comprise values extracted from a label of the first inventory item. The first inventory item is identified from the plurality of inventory items of the particular item type based on the values extracted from the label of the first inventory item. Responsive to identifying the first inventory item, a status is assigned to the first inventory item indicating that the first inventory item has been removed from the inventory storage area.

### FIELD

This application claims the benefit of, and priority based on, 35 U.S.C. § 119 to U.S. Provisional Application No. 63/669,900, filed July 11, 2024, the disclosure of which is incorporated herein by reference in its entirety.

### FIELD

The present disclosure relates generally to vision-based management of inventories. More particularly, the present disclosure relates to leveraging computer vision techniques to efficiently identify and manage inventory transactions.

### BACKGROUND

Inventory "management" refers to a systematic approach to sourcing, storing, and utilizing inventory items. Successful inventory management implements systems to track and update the current status (e.g., location, utilization, availability, etc.) of each item in the inventory to ensure that an optimal amount of inventory is available at the particular times. Inventory management is a highly complex task in a variety of different industries. Advancements in computing technologies have recently been leveraged to optimize such inventory management systems. For example, some inventory management systems attach Radio Frequency Identification (RFID) tags to inventory items to more easily maintain digital records for inventory management.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method includes obtaining, by a computing system comprising one or more computing devices, one or more first images depicting removal of a first inventory item of a plurality of inventory items of a particular item type from an inventory storage area. The method includes processing, by the computing system, the one or more first images with one or more machine-learned computer vision models to generate one or more model outputs, wherein the one or more model outputs identify an item type for the inventory item, and wherein the one or more model outputs comprise values extracted from a label of the first inventory item. The method includes identifying, by the computing system, the first inventory item from the plurality of inventory items of the particular item type based on the values extracted from the label of the first inventory item. The method includes, responsive to identifying the first inventory item, assigning, by the computing system, a status to the first inventory item, wherein the status indicates that the first inventory item has been removed from the inventory storage area.

Another example aspect of the present disclosure is directed to a computing system. The computing system includes one or more processors and one or more non-transitory computer-readable media that store instructions that, when executed by the one or more processors, cause the computing system to perform operations. The operations include obtaining one or more first images depicting removal of a first inventory item of a plurality of inventory items of a particular item type from an inventory storage area. The operations include processing the one or more first images with one or more machine-learned computer vision models to generate one or more model outputs, wherein the one or more model outputs identify an item type for the inventory item, and wherein the one or more model outputs comprise values extracted from a label of the first inventory item. The operations include identifying the first inventory item from the plurality of inventory items of the particular item type based on the values extracted from the label of the first inventory item. The operations include, responsive to identifying the first inventory item, assigning a status to the first inventory item, wherein the status indicates that the first inventory item has been removed from the inventory storage area.

Another example aspect of the present disclosure is directed to one or more non- transitory computer-readable media that store instructions that, when executed by one or more processors, cause the one or more processors to perform operations. The operations include obtaining one or more first images depicting removal of a first inventory item of a plurality of inventory items of a particular item type from an inventory storage area. The operations include processing the one or more first images with one or more machine-learned computer vision models to generate one or more model outputs, wherein the one or more model outputs identify an item type for the inventory item, and wherein the one or more model outputs comprise values extracted from a label of the first inventory item. The operations include identifying the first inventory item from the plurality of inventory items of the particular item type based on the values extracted from the label of the first inventory item. The operations include, responsive to identifying the first inventory item, assigning a status to the first inventory item, wherein the status indicates that the first inventory item has been removed from the inventory storage area.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1is a block diagram of a computing environment for vision-based autonomous inventory management according to some implementations of the present disclosure.

FIGS. 2A-2C depict an example inventory storage area with cameras for detection and identification of inventory transactions according to some implementations of the present disclosure.

FIG. 3 is a data flow diagram for utilization of the item type identifier for evaluation of item dimension information stored within the item storage area of FIGS. 2A-2C according to some implementations of the present disclosure.

FIG. 4 depicts a flow chart diagram of an example method to perform vision-based autonomous inventory management according to example embodiments of the present disclosure.

FIG. 5A depicts a block diagram of an example computing system that performs vision-based autonomous inventory system management according to example embodiments of the present disclosure.

FIG. 5B depicts a block diagram of an example computing device that performs training of computer vision models according to example embodiments of the present disclosure.

FIG. 5C depicts a block diagram of an example computing device that utilizes computer vision models for autonomous vision-based inventory management according to example embodiments of the present disclosure.

Reference numerals that are repeated across plural figures are intended to identify the same features in various implementations.

### DETAILED DESCRIPTION

### Overview

Generally, the present disclosure is directed to leveraging computer vision techniques to efficiently identify and manage inventory transactions. More specifically, inventory "management" refers to a systematic approach to sourcing, storing, and utilizing inventory items. Inventory management systems generally function by tracking and updating the current status of each inventory item within the inventory. For example, when an item is first added to an inventory management system, the item can be registered and an initial status can be assigned to the item (e.g., an "available") status. If the item is stored within an inventory storage area, the inventory management system can indicate the particular inventory storage area where the item is stored. If the item is removed from the inventory (e.g., for consumption), the status assigned to the item can be updated (e.g., updated from "available" to "unavailable" or similar).

Successful inventory management implements systems to track and updatethe current status (e.g., location, utilization, availability, etc.) of each item in the inventory to ensure that an optimal amount of inventory is available at the particular times. Inventory management is a highly complex task in a variety of different industries. Advancements in computing technologies have recently been leveraged to optimize such inventory management systems. For example, some inventory management systems attach Radio Frequency Identification (RFID) tags to inventory items to more easily maintain digital records for inventory management.

The complexities inherent to inventory management can be exacerbated in fields where accuracy and speed are critical, such as hospitals and other medical facilities. For example, the accuracy with which an inventory management system tracks the last known location of a particular medical device or medication can directly affect how quickly the item can be used to assist a patient, and can thus substantially impact patient outcomes. As such, inventory management techniques that improve accuracy and speed can be leveraged to improve patient care.

Conventional inventory management systems generally utilize RFID tags, or the like, to manage inventories for medical facilities. For example, when a medical device is added to an inventory management system, the medical device is registered and an RFID tag is attached to the device. When a user removes the medical device from the inventory to use, the user can scan the RFID tag with a specialized scanning device to update the status of the medical device (e.g., from an "available" status to an "in-use" status or the like). However, such conventional approaches exhibit a number of inefficiencies. For example, conventional systems generally require users to manually scan the RFID tag attached to an inventory item before using the item so that the status of the item can be updated in the management system. However, in some medical contexts, the time required to perform this requirement can affect patient outcomes. Due to this effect on patient outcomes, medical providers often ignore conventional inventory management procedures (e.g., tag scanning, etc.) to more optimally care for patients, thus reducing the effectiveness of the inventory management system.

Conventional inventory management systems also demonstrate inefficiencies outside of the context of medical facilities. For example, the creation of a unique RFID tag or the like for each item in an inventory management system requires specialized tools and training for individuals interacting with inventory items. Furthermore, conventional inventory management systems have few, if any, techniques to mitigate inventory discrepancies which can occur when inventory management procedures are not followed. For example, if a user forgets to scan an RFID tag before removing an item from an inventory, conventional inventory management systems cannot detect the removal of the item.

Accordingly, implementations described herein propose vision-based autonomous inventory management. More specifically, assume that inventory items for a medical facility are stored within an inventory storage area (e.g., a supply closet, a dispensary, etc.). Image capture devices, such as cameras, can be positioned within the inventory storage area such that removal of any inventory item will be captured by one (or more) of the cameras. Further, in some implementations, additional camera(s) can be placed to identify specific users who have interacted with items stored in the inventory storage area. In concert, the cameras can be leveraged to detect removal of item(s) from the inventory storage area, identify which item(s) have been removed, determine an identity of the person that removed the item(s), and then update an inventory management system that tracks the status and location of the removed item(s).

For example, assume that a user removes a medical device from the above- mentioned inventory storage area. A computing system can obtain one or more first images depicting the removal of the medical device from the inventory storage area. In some implementations, the first image(s) can depict the medical device being removed and a face of the user removing the medical device. The computing system can process the first image(s) with one or more machine-learned computer vision models to generate one or more model outputs. For example, the computing system may process some (or all) of the first image(s) with an object recognition model to identify the particular medical device being removed. For another example, the computing system may process the first image(s) with a facial recognition model to identify the user removing the medical device from the storage area. For yet another example, the computing system may process the first image(s) with an Optical Character Recognition (OCR) model (or deterministic OCR technique) to extract values from the label of the item being removed (e.g., serial number, manufacturer, etc.).

In particular, the model output(s) generated by the computing system can identify an item type for the medical device. For example, if the medical device is a pair of scissors, the model output may be an object recognition output that recognizes a scissors item type. The model output(s) can also include the values extracted from the label of the medical device. Generally, it is common for the item removed from the inventory storage area to be one of multiple devices of the same type (e.g., multiple pairs of scissors). As such, in some instances, the model output(s) may identify an "item type" (e.g., a pair of scissors) without determining a specific identity of the medical device.

Based on the values extracted from the label of the medical device, the computing system can identify the medical device from a plurality of inventory items of the same item type. To follow the previous example, assume that the model output(s) indicate that the item type is a pair of scissors. Further assume that the extracted label values for the scissors are included in the model output(s). Based on the model output(s), the computing system can search the inventory management system to identify a pair of scissors with a particular label value that matches one of the extracted label values (e.g., a serial number, manufacturer, manufacturing date, etc.). In such fashion, the computing system can determine a specific identity of the medical device being removed from the inventory storage area.

Responsive to identifying the medical device, the computing system can assign a status to the first inventory item. For example, once the medical device has been identified, the computing system can assign an "in-transit" status to the medical device until the medical device is consumed or is returned to the inventory storage area. If the medical device is returned to the inventory storage area, the return of the medical device can be detected and used to update the status of the medical device in the inventory management system as described previously. In such fashion, implementations described herein obviate the aforementioned inefficiencies of conventional inventory management systems associated with detection and identification of inventory transactions.

With reference now to the Figures, example embodiments of the present disclosure will be discussed in further detail.

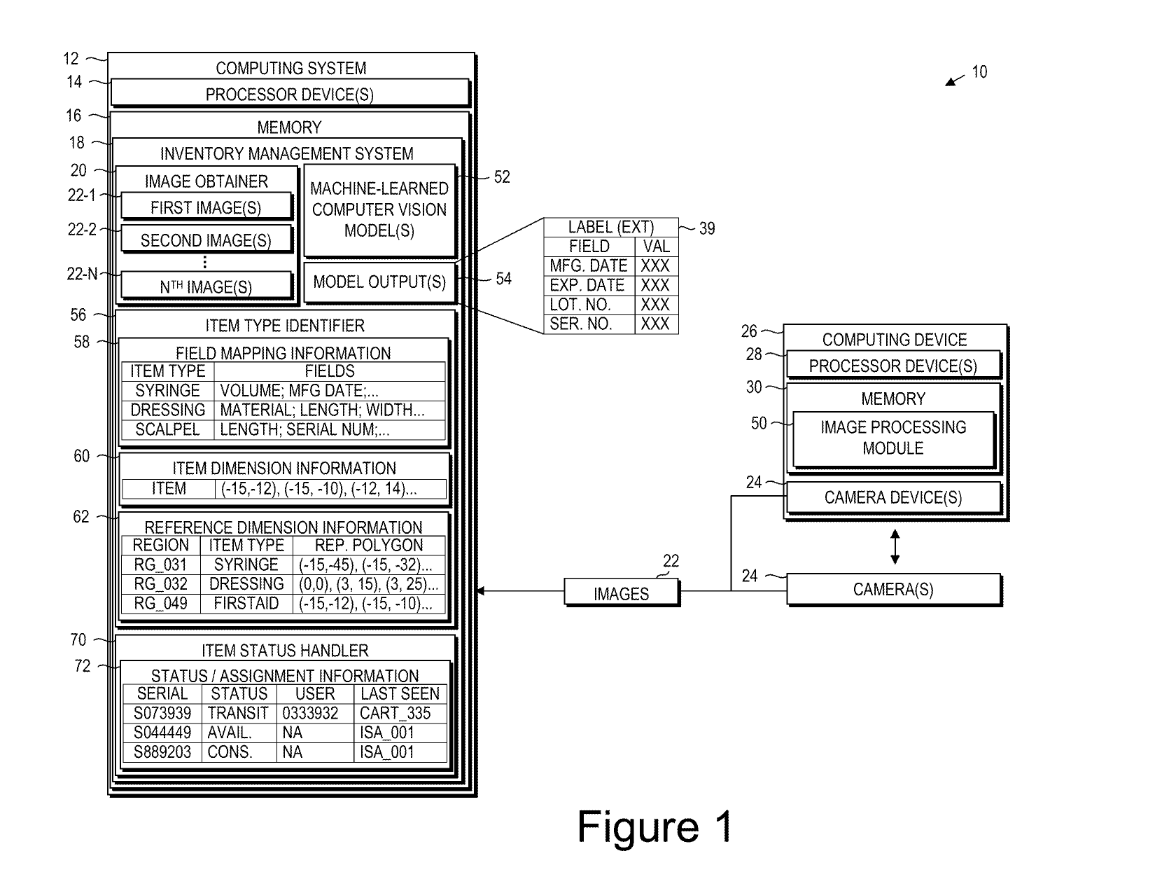

FIG. 1is a block diagram of a computing environment 10 for vision-based autonomous inventory management according to some implementations of the present disclosure. More specifically, the computing environment 10 can be any type or manner of computing environment implemented by one or more different entities, such as a medical facility, medical service provider, inventory management facility or area, business entity, etc. The computing environment 10 can include any type or manner of computing device, network device, image capture device, inventory management device, etc. For example, the computing environment 10 can be an environment implemented by a medical facility, and can include various devices and infrastructure that collectively enable an inventory management system. In some implementations, the computing environment 10 can include purpose-built inventory management devices, such as mobile devices that include cameras for detecting and identifying the removal or addition of inventory items.

The computing environment 10 can include a computing system 12. The computing system 12 can include processor device(s) 14 and memory 16. In some implementations, the computing system 12 may be a computing system that includes multiple computing devices. Alternatively, in some implementations, the computing system 12 may be one or more computing devices within a computing environment that includes multiple distributed devices and/or systems. Similarly, the processor device(s) 14 may include any computing or electronic device capable of executing software instructions to implement the functionality described herein. For example, the computing system 12 may be, or include, one or more computing device(s) located within a medical facility to implement an inventory management system for that inventory. Additionally, or alternatively, the computing system 12 can include computing device(s) located remotely from the medical facility (e.g., cloud-based device(s), virtualized devices, etc.).

The memory 16 can be or otherwise include any device(s) capable of storing data, including, but not limited to, volatile memory (random access memory, etc.), non-volatile memory, storage device(s) (e.g., hard drive(s), solid state drive(s), etc.). In particular, the memory 16 can include a containerized unit of software instructions (i.e., a "packaged container"). The containerized unit of software instructions can collectively form a container that has been packaged using any type or manner of containerization technique.

The containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

The memory 16 can include an inventory management system 18. The inventory management system 18 can perform or otherwise facilitate operations to detect and identify changes made to inventory items managed by the inventory management system 18. When an inventory item is first added to the inventory management system 18, a label can be created for and attached to the inventory item. The label can include various values for fields associated with the particular inventory item (or for a particular type of inventory item). The fields associated with the inventory item can depend based on the inventory item type. For example, medication items generally include an expiration date field, manufacturing batch number, serial number, dosage information, etc., while a medical device may include a manufacturing date, versioning information, etc.

The inventory management system 18 can include an image obtainer 20.

The inventory management system 18 can include an image obtainer 20. The image obtainer 20 can obtain first images 22-1 - N^{th} images 22-N (generally, images 22). The images 22 can be captured by camera(s) 24 positioned within an inventory storage area. As such, the images 22 can depict the inventory storage area and any changes to items stored within the inventory storage area. As described herein, an "inventory storage area" can refer to any typer or manner of area, room, vehicle, device, etc. in which inventory items can be stored. For example, an inventory storage area may refer to a supply closet, a mobile delivery vehicle, a mobile medication dispensary, etc. In some instances, an inventory storage area may be included within another inventory storage area. For example, a device used to move inventory items (e.g., a cart, trolley, kiosk, etc.) located within an inventory storage area (e.g., a supply closet) may also be referred to as an inventory storage area.

In some implementations, the camera(s) 24 can be included in, or communicatively coupled to, the computing system 12. For example, the computing system 12 may be communicatively coupled to the camera(s) 24 located within an inventory storage area. Additionally, or alternatively, in some implementations, the image obtainer 20 can obtain the images from a computing device 26. The computing device 26 can be another device or system within the computing environment 10 that facilitates capture of the images 22 via the camera(s) 24. The computing device 26 can include processor device(s) 28 and memory 30 as described with regards to the processor device(s) 14 and the memory 16 of the computing system 12.

The memory 30 of the computing device 26 can include an image capture module 32. In some implementations, the image capture module 32 can cause the camera(s) 24 to capture images within the inventory storage area. Additionally, or alternatively, in some implementations, the camera(s) 24 can determine to capture images based on detected movement or some other stimuli (e.g., passage of a particular period of time since a preceding image was captured, a random image capture, a scheduled image capture, etc.). In some implementations, the image capture module 32 can process some or all of the images 22 prior to transmitting the images 22 to the computing system 12.

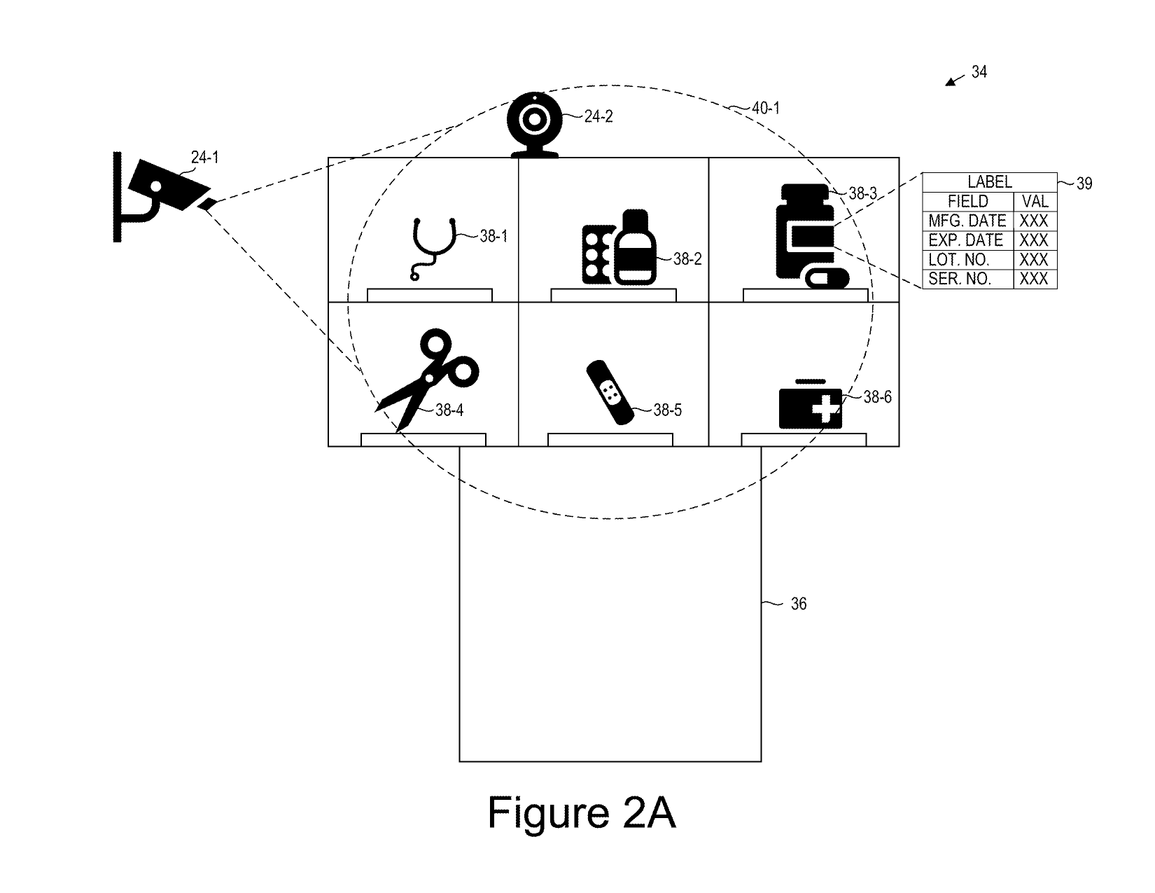

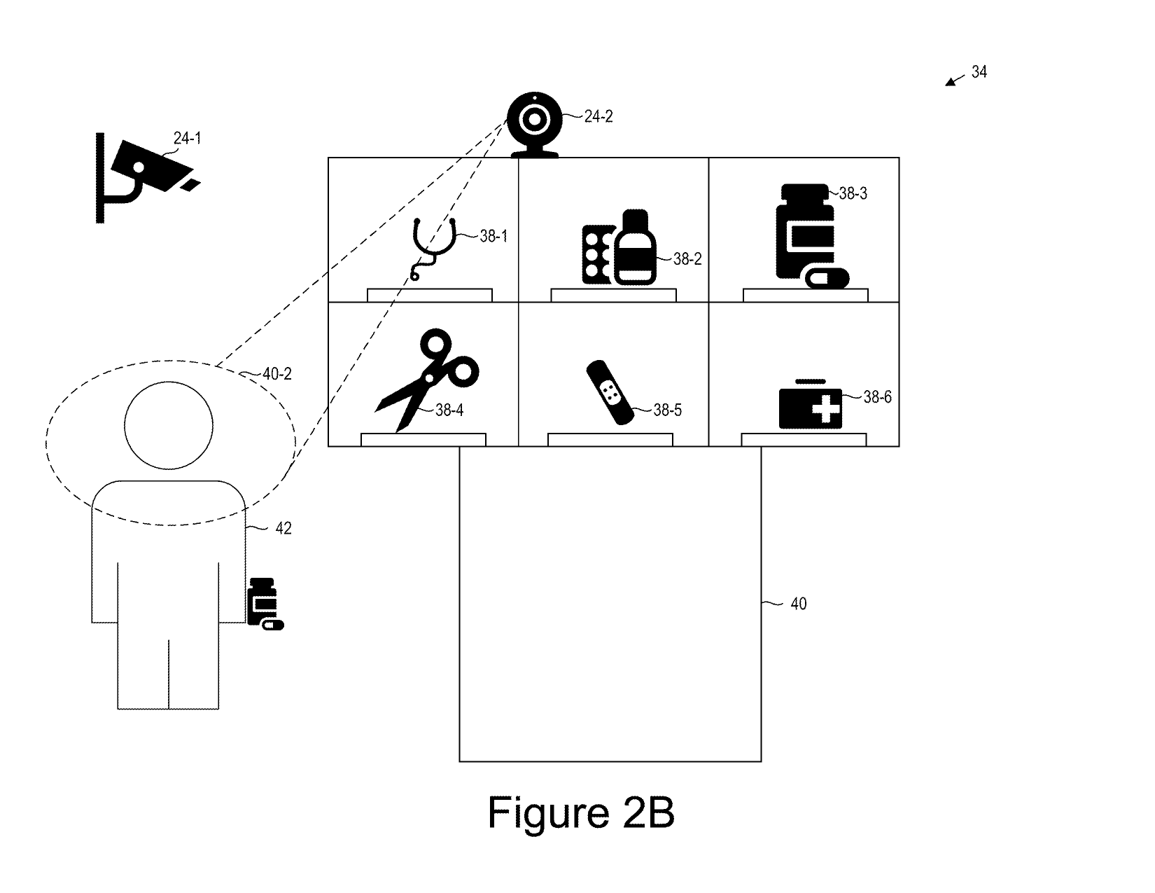

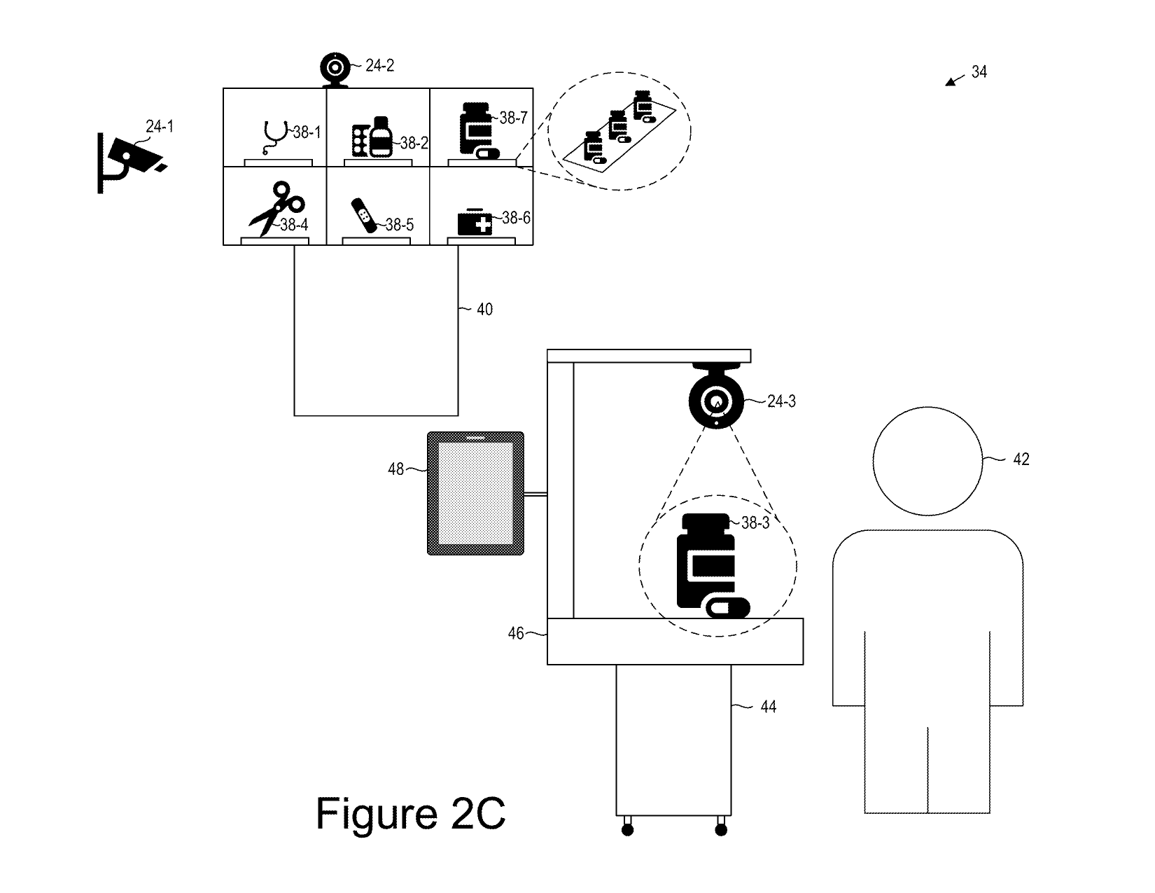

The computing device 26 can be any type or manner of device capable of orchestrating the camera(s) 24 to capture the images 22. For a more specific example, turning to FIGS. 2A-2C, FIGS. 2A-2C depict an example inventory storage area 34 with cameras 24 for detection and identification of inventory transactions according to some implementations of the present disclosure. FIGS. 2A-2C will be discussed in conjunction with FIG. 1. More specifically, turning to FIG. 2A, the inventory storage area 34 can include storage infrastructure 36 (e.g., shelving, cabinetry, storage racks, hangers, boxes, etc.). The storage infrastructure 36 can store a plurality of inventory items 38-1 - 38-7 (generally, inventory items 38). The inventory storage area 34 can also include cameras 24. Specifically, the inventory storage area can include a first camera 24-1 and a second camera 24-2.

The first camera 24-1 can be positioned with an unobstructed line of sight to the inventory items 38. In this manner, the first camera 24-1 can detect any interactions between users and the inventory items 38 stored using the storage infrastructure 36. To follow the depicted example, a Field of View (FOV) 40-1 of the first camera 24-1 can include each of the inventory items 38. The second camera 24-2 can be positioned separately from the first camera 24-1 so that the second camera 24-2 can capture a face of any user that interacts with the inventory items 38.

The first camera 24-1, or another of the camera(s) 24, can be positioned within the inventory storage area 34 such that labels attached to the inventory items 38 can be captured. In particular, the first camera 24-1 can be positioned to capture images that depict the labels at a resolution sufficient to extract values from the labels. To follow the depicted example, the first camera 24-1 can capture an image of a label 39 attached to the inventory item 38-3. The label 39 can include a number of values that correspond to certain fields associated with the item type of the inventory item 38-3. As a label for a medication item type, the label 39 can include values for fields such as a manufacturing date, expiration date, lot number, serial number, etc.

It should be noted that the first camera 24-1 can capture images of the label 39 separately from images depicting interactions between a user and the inventory item 38-3. For example, the first camera 24-1 may capture an image depicting the label 39 when the inventory item 38-3 is initially placed within the storage infrastructure 36. The first camera 24-1 may then capture another image when a user removes the inventory item 38-3 from the storage infrastructure 36.

For example, turning to FIG. 2B, a user 42 can enter the inventory storage area to remove the inventory item 38-3. As depicted, the second camera 24-2 is positioned so that an FOV 40-2 of the camera device includes the face of the user 42 as the user 42 removes the inventory item 38-3 from the storage infrastructure 40. The second camera 24-2 can capture images of the face of the user 42 as the user 42 retrieves the inventory item 38-3. These images can then be analyzed to determine an identity of the user 42 that removed the inventory item 38- 3.

It should be noted that images captured to determine an identity of a user that enters the inventory storage area 34 can be captured and processed in a privacy preserving manner. For example, assume that an image is captured that depicts the face of the user 42. To identify the user 42, an embedding (e.g., a vector, matrix, etc.) that represents the image can be generated. The image can then be deleted for preservation of privacy. The embedding can be used to identify the user based on a comparison between the embedding and another embedding previously generated based on an image of the user's face. In such fashion, implementations described herein can implement facial recognition while safeguarding user privacy.

Turning to FIG. 2C, in some implementations, the inventory storage area 34 can include an inventory storage device 44. The inventory storage device 44 can fulfill a variety of inventory management related functions, such as confirming the removal of inventory items, tracking in-transit inventory items, confirming consumption of inventory items, etc. In some implementations, the inventory storage device 44 can be a mobile device that can also be used to convey inventory items from one area to another. Alternatively, in some implementations, the inventory storage device 44 can be a stationary device located within the inventory storage area 34.

The inventory storage device 44 can include a third camera 24-3 and a surface 46. The third camera 24-3 can be positioned to capture inventory items placed on the surface 46. In some implementations, the inventory storage device 44 can be a registration device (e.g., a mobile registration device, etc.) that can be used to confirm removal of items from the inventory storage area 34. To follow the depicted example, the user 42 can remove the inventory item 38-3 from the storage infrastructure 40. The first camera 24-1 can capture image(s) that identify which of the inventory items 38 was removed from the storage infrastructure 40 by a user. The second camera 24-2 can capture image(s) that identify the user 42 that removed the inventory item 38-2 from the storage infrastructure 40.

If the user 42 no longer wishes to use the inventory item 38-3, the user 42 can simply place the inventory item 38-3 back in the storage infrastructure 40. The first camera 24-1 can detect placement of the inventory item 38-3 back onto the storage infrastructure 40. In some implementations, if the user 42 wishes to leave with the inventory item 38-3, the user 42 can walk out of the inventory storage area 34. The first camera 24-1, or another camera within the inventory storage area 34 (e.g., the second camera 24-2) can capture images depicting the user leaving the storage area 34.

Alternatively, in some implementations, the user 42 can confirm removal of the inventory item 38-3 by placing the inventory item 38-3 on the surface 46 of the inventory storage device 44. The third camera 24-3 can capture an image of the inventory item 38-3 in the same manner as described with regards to the first camera 24-1 to detect the inventory item 38-3. The user's intent to leave with the inventory item 38-3 can be confirmed by detecting placement of the inventory item 38-3 on the surface 46 with the third camera 24-3.

In some implementations, the inventory storage device 44 can include a display device 48. Once the camera 24-3 has captured images of the inventory item 38-3, the display device 48 can display information indicative of an identity of the inventory item 38-3. For example, the display device 48 can display a unique identifier for the inventory item 38-3. Additionally, or alternatively, in some implementations, the display device 48 can display additional details regarding the user 42 and/or the inventory item 38-3. For example, if the inventory item 38-3 has usage guidelines or restrictions, such information can be displayed via the display device 48. For another example, if an identity of the user 42 is determined based on the images captured via the second camera 24-2, the identity of the user 42 can be displayed via the display device 48 for confirmation by the user 42.

It should be noted that each of the depicted inventory items 38 can represent multiple inventory items stored within the storage infrastructure 40. In other words, although only a single item is depicted for each of the inventory items 38, additional items of the same type may be stored behind or adjacent to each of the inventory items 38. To follow the illustrated example, the area of the storage infrastructure 40 that stores the inventory item 38-3 can include an additional inventory item 38-7 of the same type (e.g., the same type of medication). The order in which inventory items are placed within the storage infrastructure 40 can be captured by the cameras 24, which will be discussed subsequently.

Returning to FIG. 1, the image obtainer 20 can include the images 22 captured using the cameras 24. As described with regards to FIGS. 2A-2C, the cameras 24 can be positioned within the inventory storage area 34. In some implementations, the cameras 24 can be managed by an image processing module 50 of the computing device 26. The image processing module 50 can modify or process the images 22 captured by the camera device(s) 24 prior to transmitting the images 22 to the computing system 12. For example, the image processing module 50 may remove specific images (i.e., video or image frames) if they are unnecessary to perform recognition operations. For another example, the image processing module 50 can downscale, crop, filter, or otherwise modify the images 22 to reduce the size of the images 22 if the size is unnecessarily large for recognition operations. In such fashion, implementations described herein can perform recognition operations more efficiently.

The image obtainer 20 can obtain the images from the computing device 26, and/or from the camera(s) 24 directly. In particular, the image obtainer 20 can obtain first images 22-1. The first images 22-1 can be captured by the first camera 24-1, and can depict the removal of a first inventory item (e.g., the inventory item 38-3) from the inventory storage area 34 (or from the storage infrastructure 36 of the inventory storage area 34). The image obtainer 20 can obtain second images 22-2 captured by the first camera 24-1. The second images 22-2 can depict the face or some other identifying feature (e.g., a badge worn by the user, etc.) of the user 42 that removed the first item from the inventory storage area 34. In some implementations, the image obtainer 20 can obtain third images 22-3 (implicitly illustrated) captured by the third camera 24- 3 of the inventory storage device 44. The third images 22-3 can depict the face or some other identifying feature (e.g., a badge worn by the user, etc.) of the user 42 that removed the first item from the inventory storage area 34.

The inventory management system 18 can include one or more machine- learned computer vision model(s) 52. The machine-learned computer vision model(s) 52 can include any type or manner of model trained to process an image (or information derived therefrom) to recognize certain characteristics of the image. The machine-learned computer vision model(s) 52 can process the images 22 to obtain model output(s) 54.

In some implementations, the machine-learned computer vision model(s) 52 can include a model capable of performing OCR operations, and the model output(s) 54 can describe values extracted from a label of the inventory item depicted by the images 22. For example, the first images 22-1 can depict the label of the inventory item, and the model output(s) 54 can include the values extracted from the label with the machine-learned computer vision model(s) 52.

Additionally, or alternatively, in some implementations, the machine- learned computer vision model(s) 52 can include a model capable of performing facial recognition operations, and the model output(s) 54 can describe an identity of a person whose face was captured. For example, the second images 22-2 can depict the face of the user 42 when the user 42 removes the inventory item 38-3 from the storage infrastructure 36. The model output(s) 54 can indicate an identity of the user 42. For a more specific example, if the second images 22-2 depict the face of the user 42, the inventory management system 18 or the image processing module 50 can process the second image(s) 22-2 so that the face of the user 42 is featured primarily. The inventory management system 18 can process the second image(s) 22-2 to generate an intermediate representation of the second image(s) 22-2. The inventory management system 18 can then perform a similarity search between the intermediate representation and other intermediate representations stored previously for identifying users in a privacy-preserving manner.

In some implementations, the machine-learned computer vision model(s) 52 can include multimodal models or models that can process inputs other than images. More specifically, in some implementations, the machine-learned computer vision model(s) 52 can include model(s) that can perform voice recognition or speech recognition. For example, assume that a user enters an inventory storage room to remove an item. The user may speak the name of the item being removed, or an identifier for the item being removed. Additionally, or alternatively, in some implementations, the user can describe an action being taken (e.g., removing an item, replacing an item, putting an item back, restocking an item, etc.).

In some implementations, the third images 22-3 (illustrated implicitly in FIG. 1) can be captured via the third camera 24-3 of the inventory storage device 44. The third images 22-3 can be processed with the machine-learned computer vision model(s) 52 as described with regards to the first image(s) 22-1. The inventory management system 18 can determine or confirm an intent of the user based on the third image(s) 22-3, which will be discussed subsequently.

In some implementations, the inventory management system 18 can include an item type identifier 56. The item type identifier 56 can identify an item type based on the images 22. Specifically, in some implementations, the item type identifier 56 can identify an item type for the inventory item being removed (e.g., the inventory item 38-3) based on an object recognition output. For example, assume that the inventory item being removed is a pair of scissors. The model output(s) 54 can include an object recognition output that classifies the pair of scissors as being a particular type(s) of item (e.g., a scissors item type, a tool item type, a medical device item type, a disposable item type, etc.).

Additionally, or alternatively, in some implementations, the item type identifier 56 can identify an item type for the inventory item being removed (e.g., the inventory item 38-3) based on an OCR output that extracts information from the label 39 attached to the inventory item being removed. For example, assume that the inventory item being removed is a bottle of medicine with a label. The model output(s) 54 can include an object recognition output that describes some of the fields and/or values of the label 39. The item type identifier 56 can store field mapping information 58 that maps types of fields to particular item types. For example, assume the model output(s) 54 extract an expiration date field, a lot number field, a dosage field, and a side effects field from the label 39. The field mapping information 58 can indicate that only the labels of medicine item types include a dosage field. In response, the item type identifier 56 can predict that the item is a medicine item type.

Additionally, or alternatively, in some implementations, the item type identifier 56 can identify both the type of item and the specific inventory item concurrently or sequentially. For example, assume that the information extracted from the label 39 includes a serial number field and a value for the serial number field. The item type identifier 56 can first determine that the inventory item is a medicine item type. The item type identifier 56 can then search for an inventory item with a medicine item type and a serial number that matches the extracted serial number. In such fashion, the item type identifier 56 can generate predictions based on the granularity of the information extracted from the label 39.

In some implementations, the inventory management system 18 can include item dimension information 60. The item dimension information 60 can describe or otherwise indicate the dimensions of items currently located in (or recently removed from) the inventory storage area 34. The item dimension information 60 can be derived from images captured with the camera(s) 24 from a static location that depict the inventory items when placed within the inventory storage area 34 (e.g., within the storage infrastructure 40, etc.). The item dimension information 60 can then be compared to reference dimension information 62 to identify the item associated with the item dimension information 60.

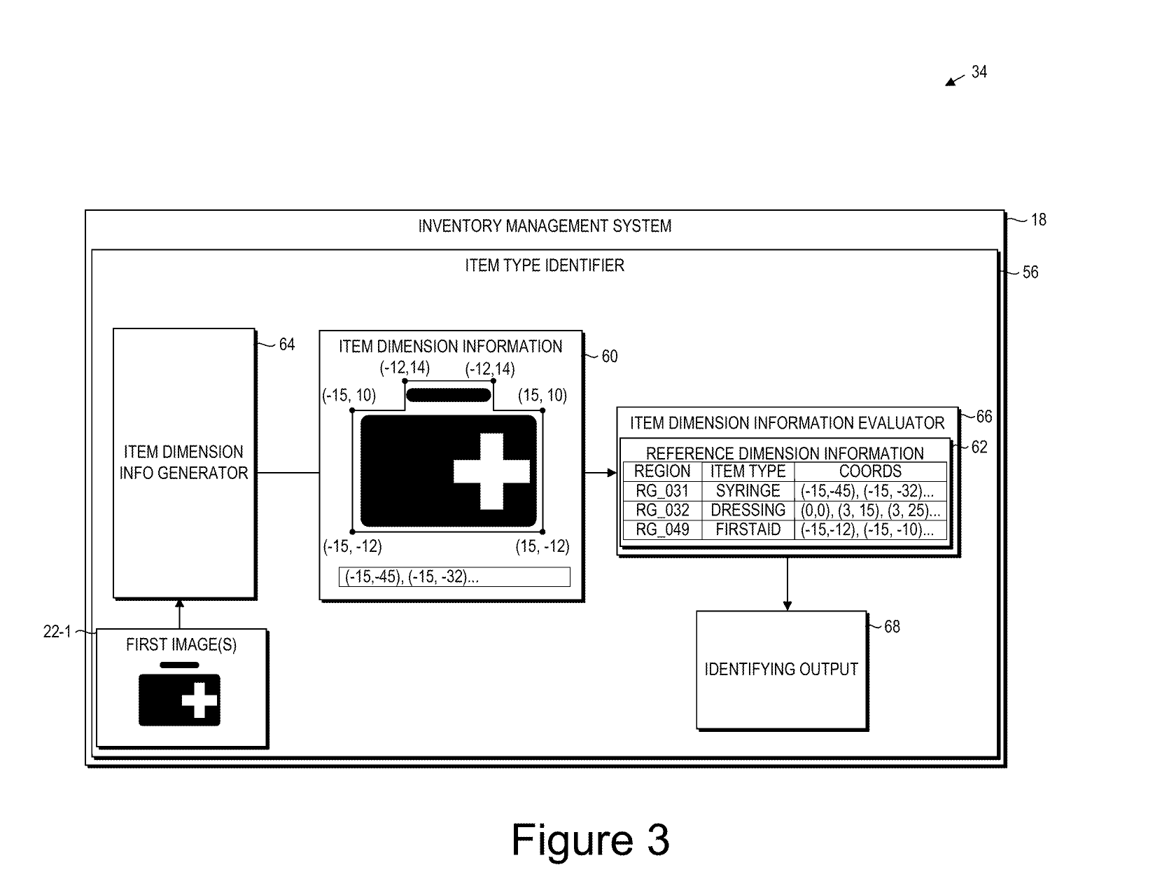

For a specific example, turning to FIG. 3, FIG. 3is a data flow diagram for utilization of the item type identifier 56 for evaluation of item dimension information stored within the item storage area of FIGS. 2A-2C according to some implementations of the present disclosure. FIG. 3 will be discussed in conjunction with FIGS. 1 and 2A-2C. More specifically, the item type identifier 56 can include an item dimension information generator 64. The item dimension information generator 64 can obtain the first image(s) 22-1. To follow the depicted example, the first image(s) 22-1 can depict the inventory item 38-6 of FIGS. 2A-2C (e.g., a first aid kit).

The item dimension information generator 64 can process the first image(s) 22-1 to generate the item dimension information 60. The item dimension information 60 can include a sequence of nodes and edges that collectively form an outline of the inventory item 38- 6. In particular, the item dimension information 60 can represent a two-dimensional outline of the inventory item 38-6 from the perspective of the first camera 24-1.

The item dimension information 60 can be compared to the reference dimension information 62 by an item dimension information evaluator 66. More specifically, when inventory items are initially placed within the inventory storage area 34, the first camera 34-1 can capture dimension information for each item (e.g., the inventory items 38). Each item can be stored in a specific location within the inventory storage area 34. The reference dimension information 62 can associate regions of the images captured with the first camera 24-1 with the reference dimensions for objects assigned to positions within the inventory storage area 34. For example, assume that an inventory item is stored in a top-left corner of the storage infrastructure 36. Because the first camera 24-1 can be static, each of the first image(s) 22-1 can consistently depict the inventory item in the same regions of the first image(s) 22-1. The reference dimension information 62 can associate the region of the first image(s) 22-1 with the specific location to which the inventory item is assigned. Because the location of the first camera 24-1 is static, and the specific locations of the inventory items 38 do not change, the reference dimension information 62 should match any subsequent dimension information derived from images captured using the first camera 34-1. As such, differences between the item dimension information 60 and the reference dimension information 62 can be used to detect incorrect placement of one of the inventory items 38 within the inventory storage area 34.

For example, assume that the first aid kit depicted by the first image(s) 22-1 is erroneously placed in a location within the inventory storage area assigned to medicine item types. The item dimension information 60 can be derived from the first image(s) 22-1 when the first aid kit is placed in the incorrect location. The reference dimension information 62 can indicate that the item dimension information 60 should match the dimension information previously derived for medicine item types. Based on the differences between the item dimension information 60 and the reference dimension information 62, the item dimension information evaluator 66 can generate an identifying output 68 indicating that the inventory item depicted by the first image(s) 22-1 has been placed in an incorrect location.

Returning to FIG. 1 , the inventory management system 18 can include an item status handler 70. The item status handler 70 can store, modify, and/or update status/assignment information 72. The status/assignment information 72 can track a status, associated user, and location for each of the inventory items 38. As described herein, a "status" for an inventory item generally refers to a current state of utilization for the inventory item in question. For example, an item that was removed from the inventory storage area 34 and has not been identified subsequently may have a status of "in transit." For another example, if an item is removed and then consumed, and the consuming user indicates that the item was consumed (or if a certain amount of time passes without receiving confirmation from the user), the item may have a status of "consumed," and/or may be removed from the status/assignment information 72. For yet another example, if an item is currently located in the inventory storage area 34 and has not been removed, the item may have a status of "available."

### Example Methods

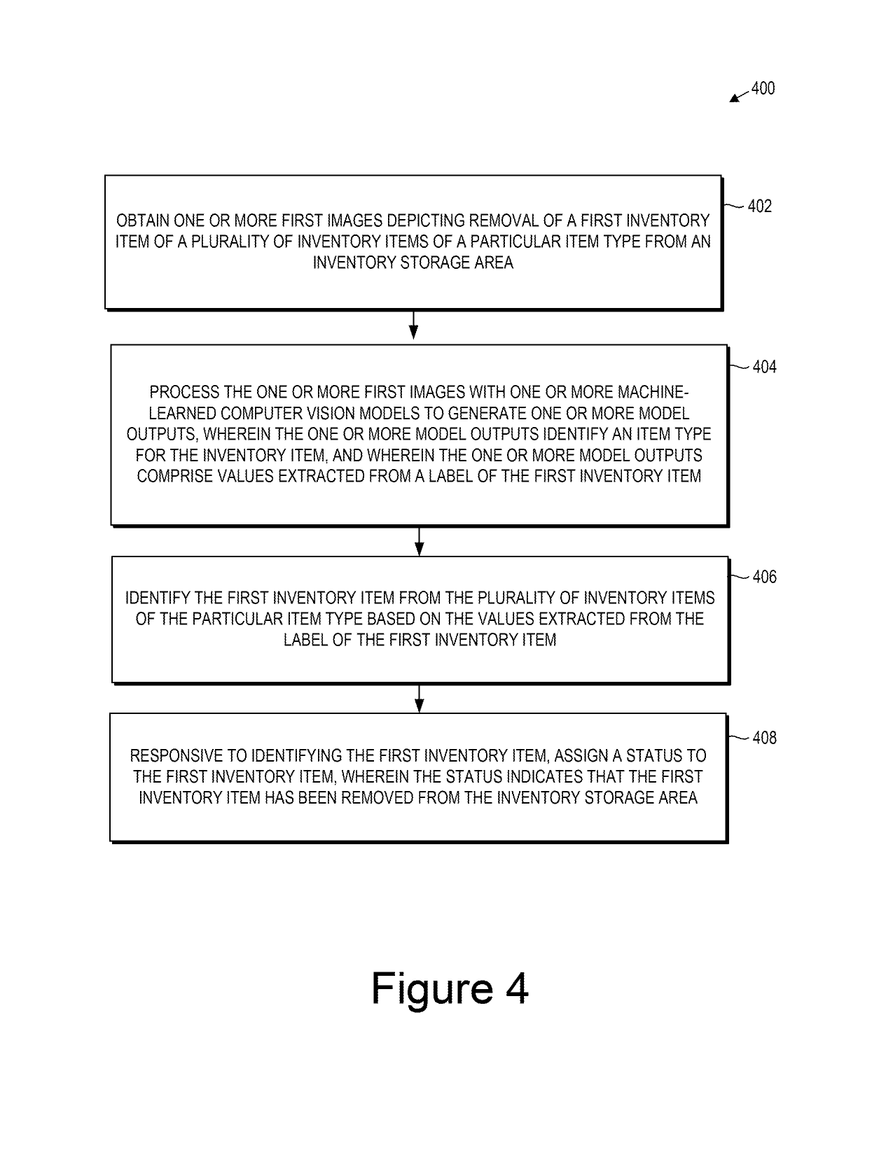

FIG. 4depicts a flow chart diagram of an example method to perform vision-based autonomous inventory management according to example embodiments of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, a computing system can obtain one or more first images depicting removal of a first inventory item of a plurality of inventory items of a particular item type from an inventory storage area. In some implementations, to obtain the one or more first images depicting the removal of the first inventory item, the computing system can obtain a removal image of the one or more first images, wherein the removal image depicts a user removing the first inventory item from the inventory storage area. The computing system can obtain a facial capture image of the one or more first images. The facial capture image can depict a face of the user removing the first inventory item from the inventory storage area.

At 404, the computing system can process the one or more first images with one or more machine-learned computer vision models to generate one or more model outputs. The one or more model outputs can identify an item type for the inventory item. The one or more model outputs can include values extracted from a label of the first inventory item.

In some implementations, to process the one or more first images with the one or more machine-learned computer vision models to generate the one or more model outputs, the computing system can process the facial capture image of the one or more first images with a facial recognition model of the one or more machine-learned computer vision models to obtain a facial recognition output of the one or more model outputs. The facial recognition output can be indicative of an identity of the user. To assign the status to the first inventory item, the computing system can assign the first inventory item to the first user based on the facial recognition output. In some implementations, the removal image is captured using a first camera device located within the inventory storage area, and the facial capture image is captured using a second camera device located separately from the first camera device within the inventory storage area.

At 406, the computing system can identify the first inventory item from the plurality of inventory items of the particular item type based on the values extracted from the label of the first inventory item.

At 408, the computing system can, responsive to identifying the first inventory item, assign a status to the first inventory item. The status can indicate that the first inventory item has been removed from the inventory storage area. In some implementations, the computing system can obtain one or more second images depicting placement of the first inventory item on a surface. The computing system can obtain one or more third images depicting removal of the first inventory item from the surface. The computing system can, based on the one or more third images, assign a consumed status to the first inventory item. The consumed status can indicate that the first inventory item has been consumed. In some implementations, the surface can include a surface of a mobile registration device including a camera device. The camera device can be used to capture the one or more second images and the one or more third images. In some implementations, the one or more first images are captured using a separate camera device located within the inventory storage area.

In some implementations, the computing system can obtain one or more fourth images depicting the first inventory item being returned to the inventory storage area. Based on the one or more fourth images, the computing system can assign an available status to the first inventory item indicating that the first inventory item is available at the inventory storage area.

In some implementations, to obtain the one or more fourth images depicting the first inventory item being returned to the inventory storage area, the computing system can process the one or more fourth images with at least one of the one or more machine-learned computer vision models to obtain a spatial output indicative of a particular storage location that the first inventory item was returned to. The particular storage location can be one of a plurality of storage locations within the inventory storage area, each of the plurality of storage locations being associated with a corresponding item type of a plurality of item types. The computing system can determine whether the particular storage location that the first inventory item was returned to is associated with the particular item type.

In some implementations, to determine whether the particular storage location is associated with the particular item type, the computing system can make a determination that the particular storage location is associated with the particular item type. Responsive to the determination, the computing system can cause display of a notification indicating that the first inventory item has been returned to a correct location.

In some implementations, to determine whether the particular storage location that the first inventory item was returned to is associated with the particular item type, the computing system can make a determination that the particular storage location is associated with a second item type different than the particular item type. Responsive to the determination, the computing system can cause display of a notification indicating that the first inventory item has been returned to an incorrect location.

In some implementations, prior to making the determination that the particular storage location is associated with the second item type different than the particular item type, the computing system can capture a planogram image that includes a plurality of image regions. Each of the plurality of image regions can depict a corresponding storage location of the plurality of storage locations within the inventory storage area. The computing system can generate inventory mapping information that maps each of the plurality of item types to a corresponding image region of the plurality of image regions.

In some implementations, to make the determination that the particular storage location is associated with the second item type different than the particular item type, the computing system can make the determination that the particular storage location is associated with the second item type different than the particular item type based on the inventory mapping information.

### Example Devices and Systems

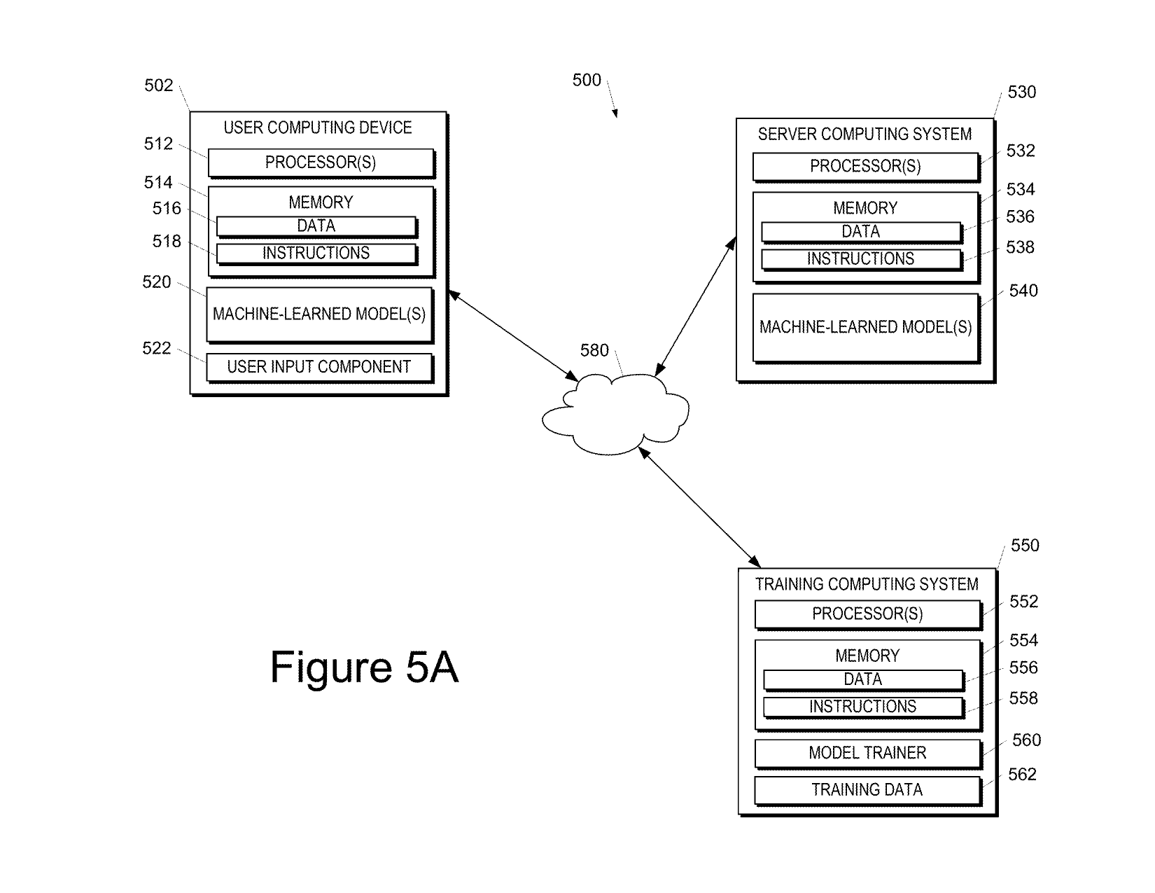

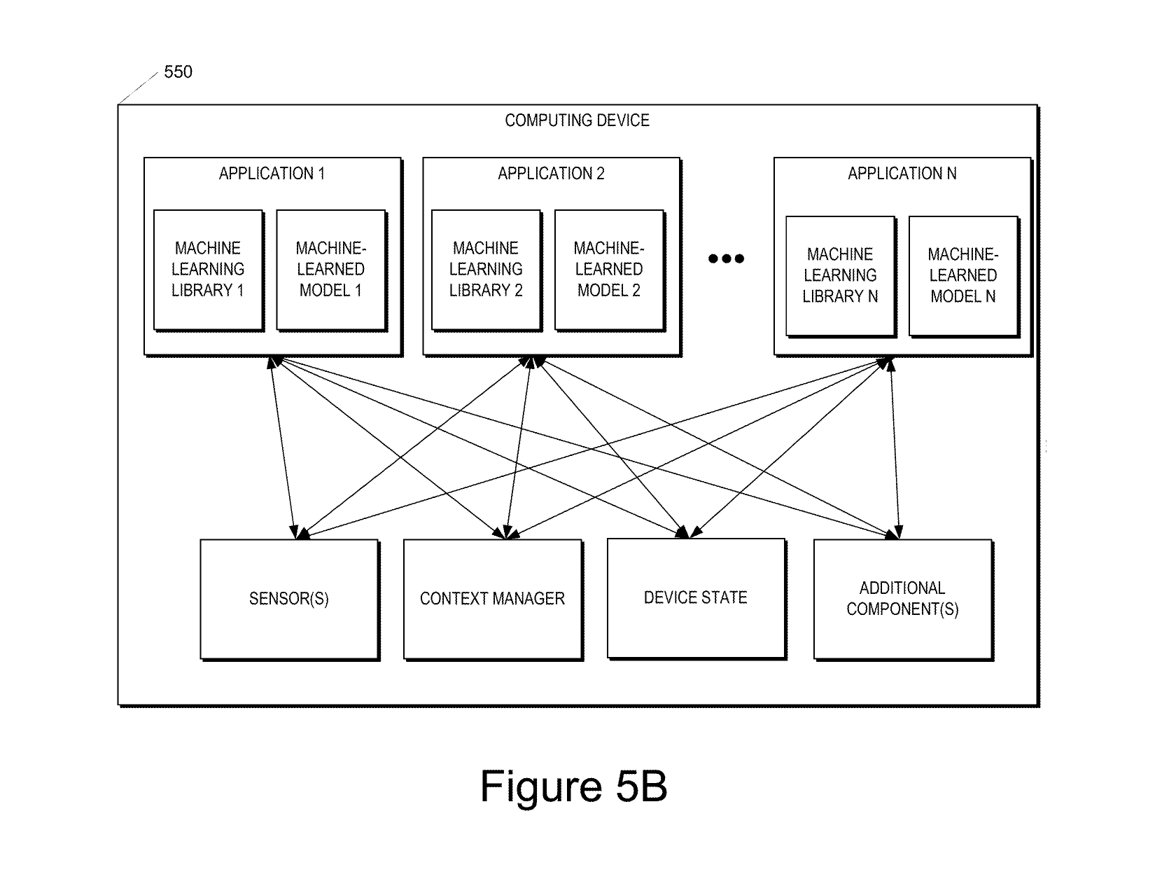

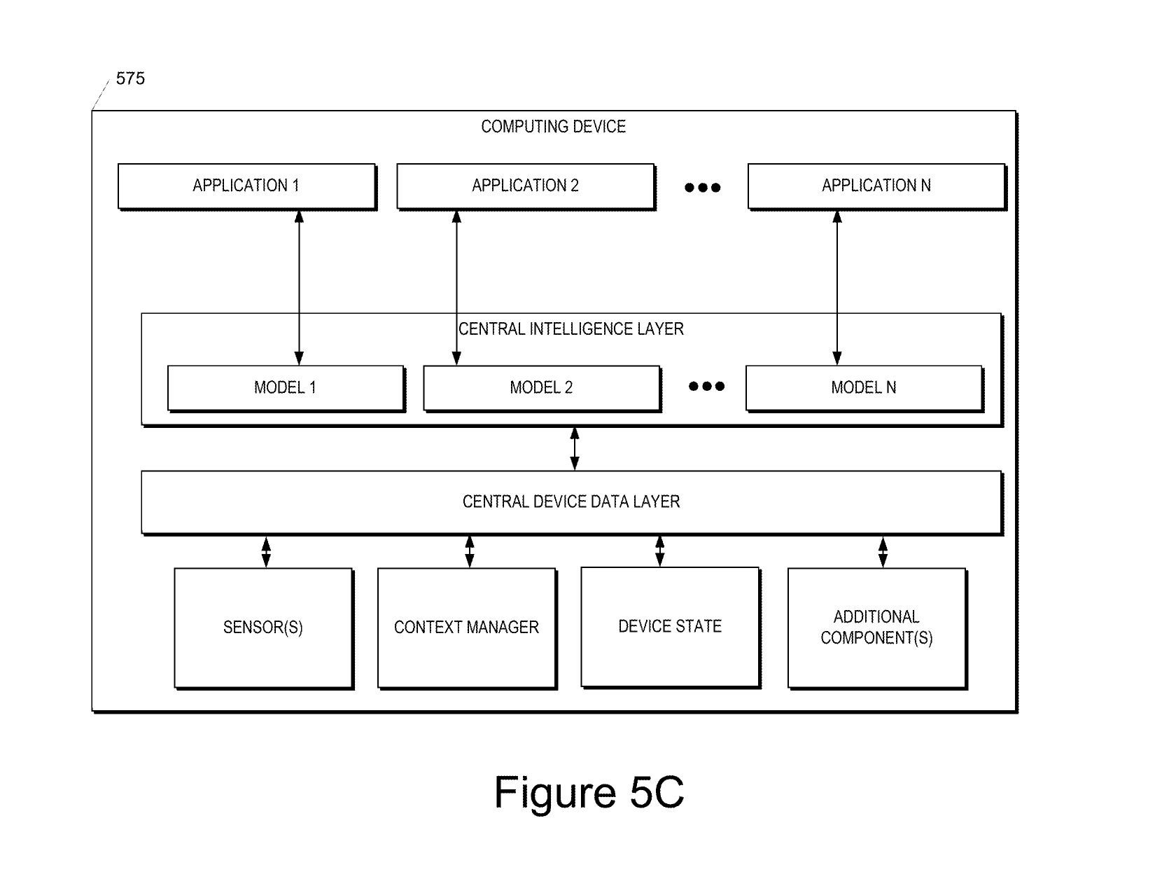

FIG. 5A depicts a block diagram of an example computing system 500 that performs vision-based autonomous inventory system management according to example embodiments of the present disclosure. The system 500 includes a user computing device 502, a server computing system 530, and a training computing system 550 that are communicatively coupled over a network 580.

The user computing device 502 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 502 includes one or more processors 512 and a memory 514. The one or more processors 512 can be any suitable processing device (e.g., a processor core, a microprocessor, an ASIC, an FPGA, a controller, a microcontroller, etc.) and can be one processor or a plurality of processors that are operatively connected. The memory 514 can include one or more non-transitory computer-readable storage media, such as RAM, ROM, EEPROM, EPROM, flash memory devices, magnetic disks, etc., and combinations thereof. The memory 514 can store data 516 and instructions 518 which are executed by the processor 512 to cause the user computing device 502 to perform operations.

In some implementations, the user computing device 502 can store or include one or more machine-learned computer vision models 520. For example, the machine-learned computer vision models 520 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine- learned models can leverage an attention mechanism such as self-attention. For example, some example machine-learned models can include multi-headed self-attention models (e.g., transformer models). Example machine-learned computer vision models 520 are discussed with reference to FIGS. 1-3.

In some implementations, the one or more machine-learned computer vision models 520 can be received from the server computing system 530 over network 580, stored in the user computing device memory 514, and then used or otherwise implemented by the one or more processors 512. In some implementations, the user computing device 502 can implement multiple parallel instances of a single machine-learned computer vision model 520 (e.g., to perform parallel computer vision tasks across multiple instances of the model(s)).

Additionally, or alternatively, one or more machine-learned computer vision models 540 can be included in or otherwise stored and implemented by the server computing system 530 that communicates with the user computing device 502 according to a client-server relationship. For example, the machine-learned computer vision models 540 can be implemented by the server computing system 530 as a portion of a web service. Thus, one or more models 520 can be stored and implemented at the user computing device 502 and/or one or more models 540 can be stored and implemented at the server computing system 530.

The user computing device 502 can also include one or more user input components 522 that receives user input. For example, the user input component 522 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 530 includes one or more processors 532 and a memory 534. The one or more processors 532 can be any suitable processing device (e.g., a processor core, a microprocessor, an ASIC, an FPGA, a controller, a microcontroller, etc.) and can be one processor or a plurality of processors that are operatively connected. The memory 534 can include one or more non-transitory computer-readable storage media, such as RAM, ROM, EEPROM, EPROM, flash memory devices, magnetic disks, etc., and combinations thereof. The memory 534 can store data 536 and instructions 538 which are executed by the processor 532 to cause the server computing system 530 to perform operations.

In some implementations, the server computing system 530 includes or is otherwise implemented by one or more server computing devices. In instances in which the server computing system 530 includes plural server computing devices, such server computing devices can operate according to sequential computing architectures, parallel computing architectures, or some combination thereof.

As described above, the server computing system 530 can store or otherwise include one or more machine-learned computer vision models 540. For example, the models 540 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 540 are discussed with reference to FIGS. 1-3.

The user computing device 502 and/or the server computing system 530 can train the models 520 and/or 540 via interaction with the training computing system 550 that is communicatively coupled over the network 580. The training computing system 550 can be separate from the server computing system 530 or can be a portion of the server computing system 530.

The training computing system 550 includes one or more processors 552 and a memory 554. The one or more processors 552 can be any suitable processing device (e.g., a processor core, a microprocessor, an ASIC, an FPGA, a controller, a microcontroller, etc.) and can be one processor or a plurality of processors that are operatively connected. The memory 554 can include one or more non-transitory computer-readable storage media, such as RAM, ROM, EEPROM, EPROM, flash memory devices, magnetic disks, etc., and combinations thereof. The memory 554 can store data 556 and instructions 558 which are executed by the processor 552 to cause the training computing system 550 to perform operations. In some implementations, the training computing system 550 includes or is otherwise implemented by one or more server computing devices.

The training computing system 550 can include a model trainer 560 that trains the machine-learned models 520 and/or 540 stored at the user computing device 502 and/or the server computing system 530 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 560 can perform a number of generalization techniques (e.g., weight decays, dropouts, etc.) to improve the generalization capability of the models being trained.

In particular, the model trainer 560 can train the machine-learned computer vision models 520 and/or 540 based on a set of training data 562. The training data 562 can include, for example, image recognition training examples, dimensional analysis training examples, OCR training examples, unsupervised training examples, etc.

In some implementations, if the user has provided consent, the training examples can be provided by the user computing device 502. Thus, in such implementations, the model 520 provided to the user computing device 502 can be trained by the training computing system 550 on user-specific data received from the user computing device 502. In some instances, this process can be referred to as personalizing the model.

The model trainer 560 includes computer logic utilized to provide desired functionality. The model trainer 560 can be implemented in hardware, firmware, and/or software controlling a general purpose processor. For example, in some implementations, the model trainer 560 includes program files stored on a storage device, loaded into a memory and executed by one or more processors. In other implementations, the model trainer 560 includes one or more sets of computer-executable instructions that are stored in a tangible computer-readable storage medium such as RAM, hard disk, or optical or magnetic media.

The network 580 can be any type of communications network, such as a local area network (e.g., intranet), wide area network (e.g., Internet), or some combination thereof and can include any number of wired or wireless links. In general, communication over the network 580 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. For example, the machine-learned computer vision model(s) 520/540 can include a speech encoder to process a spoken utterance from a user who has removed an item from the inventory storage area. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

FIG. 5A illustrates one example computing system that can be used to implement the present disclosure. Other computing systems can be used as well. For example, in some implementations, the user computing device 502 can include the model trainer 560 and the training dataset 562. In such implementations, the models 520 can be both trained and used locally at the user computing device 502. In some of such implementations, the user computing device 502 can implement the model trainer 560 to personalize the models 520 based on user- specific data.

FIG. 5B depicts a block diagram of an example computing device 550 that performs training of computer vision models according to example embodiments of the present disclosure. The computing device 550 can be a user computing device or a server computing device.

The computing device 550 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 5B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 5C depicts a block diagram of an example computing device 575 that utilizes computer vision models for autonomous vision-based inventory management according to example embodiments of the present disclosure. The computing device 575 can be a user computing device or a server computing device.

The computing device 575 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 5C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 575.

The central intelligence layer can communicate with a central device data layer. The central device data layer can be a centralized repository of data for the computing device 575. As illustrated in FIG. 5C, the central device data layer can communicate with a number of other components of the computing device, such as, for example, one or more sensors, a context manager, a device state component, and/or additional components. In some implementations, the central device data layer can communicate with each device component using an API (e.g., a private API).

The computing device 550 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc. As illustrated in FIG. 5B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application. Figure SC depicts a block diagram of an example computing device 575 that utilizes computer vision models for autonomous vision-based inventory management according to example embodiments of the present disclosure. The computing device 575 can be a user computing device or a server computing device. The computing device 575 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 5C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 575.

The central intelligence layer can communicate with a central device data layer. The central device data layer can be a centralized repository of data for the computing device 575. As illustrated in FIG. 5C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method, comprising:
obtaining, by a computing system comprising one or more computing devices, one or more first images depicting removal of a first inventory item of a plurality of inventory items of a particular item type from an inventory storage area;
processing, by the computing system, the one or more first images with one or more machine-learned computer vision models to generate one or more model outputs, wherein the one or more model outputs identify an item type for the inventory item, and wherein the one or more model outputs comprise values extracted from a label of the first inventory item;
identifying, by the computing system, the first inventory item from the plurality of inventory items of the particular item type based on the values extracted from the label of the first inventory item; and
responsive to identifying the first inventory item, assigning, by the computing system, a status to the first inventory item, wherein the status indicates that the first inventory item has been removed from the inventory storage area.

2. The computer-implemented method of claim 1, wherein the method further comprises:
obtaining, by the computing system, one or more second images depicting placement of the first inventory item on a surface;
obtaining, by the computing system, one or more third images depicting removal of the first inventory item from the surface; and
based on the one or more third images, assigning, by the computing system, a consumed status to the first inventory item, wherein the consumed status indicates that the first inventory item has been consumed.

3. The computer-implemented method of claim 2, wherein the surface comprises a surface of a mobile registration device comprising a camera device, and wherein the camera device is used to capture the one or more second images and the one or more third images.

4. The computer-implemented method of claim 3, wherein the one or more first images are captured using a separate camera device located within the inventory storage area.

5. The computer-implemented method of claim 1, wherein the method further comprises:
obtaining, by the computing system, one or more fourth images depicting the first inventory item being returned to the inventory storage area; and
based on the one or more fourth images, assigning, by the computing system, an available status to the first inventory item indicating that the first inventory item is available at the inventory storage area.

6. The computer-implemented method of claim 5, wherein obtaining the one or more fourth images depicting the first inventory item being returned to the inventory storage area comprises:
processing, by the computing system, the one or more fourth images with at least one of the one or more machine-learned computer vision models to obtain a spatial output indicative of a particular storage location that the first inventory item was returned to, wherein the particular storage location is one of a plurality of storage locations within the inventory storage area, each of the plurality of storage locations being associated with a corresponding item type of a plurality of item types; and
determining, by the computing system, whether the particular storage location that the first inventory item was returned to is associated with the particular item type.

7. The computer-implemented method of claim 6, wherein determining whether the particular storage location is associated with the particular item type comprises:
making, by the computing system, a determination that the particular storage location is associated with the particular item type; and
responsive to the determination, causing, by the computing system, display of a notification indicating that the first inventory item has been returned to a correct location.

8. The computer-implemented method of claim 6, wherein determining whether the particular storage location that the first inventory item was returned to is associated with the particular item type comprises:
making, by the computing system, a determination that the particular storage location is associated with a second item type different than the particular item type; and
responsive to the determination, causing, by the computing system, display of a notification indicating that the first inventory item has been returned to an incorrect location.

9. The computer-implemented method of claim 8, wherein, prior to making the determination that the particular storage location is associated with the second item type different than the particular item type, the method comprises:
capturing, by the computing system, a planogram image comprising a plurality of image regions, each of the plurality of image regions depicting a corresponding storage location of the plurality of storage locations within the inventory storage area; and
generating, by the computing system, inventory mapping information that maps each of the plurality of item types to a corresponding image region of the plurality of image regions.

10. The computer-implemented method of claim 9, wherein making the determination that the particular storage location is associated with the second item type different than the particular item type comprises:making, by the computing system, the determination that the particular storage location is associated with the second item type different than the particular item type based on the inventory mapping information.

11. The computer-implemented method of claim 1, wherein obtaining the one or more first images depicting the removal of the first inventory item comprises:
obtaining, by the computing system, a removal image of the one or more first images, wherein the removal image depicts a user removing the first inventory item from the inventory storage area; and
obtaining, by the computing system, a facial capture image of the one or more first images, wherein the facial capture image depicts a face of the user removing the first inventory item from the inventory storage area.

12. The computer-implemented method of claim 11, wherein processing the one or more first images with the one or more machine-learned computer vision models to generate the one or more model outputs comprises:
processing, by the computing system, the facial capture image of the one or more first images with a facial recognition model of the one or more machine-learned computer vision models to obtain a facial recognition output of the one or more model outputs, wherein the facial recognition output is indicative of an identity of the user; and
wherein assigning the status to the first inventory item comprises:
assigning, by the computing system, the first inventory item to the user based on the facial recognition output.

13. The computer-implemented method of claim 11, wherein the removal image is captured using a first camera device located within the inventory storage area, and wherein the facial capture image is captured using a second camera device located separately from the first camera device within the inventory storage area.

14. The computer-implemented method of claim 1, wherein the values extracted from the label comprise at least one of:
a manufacturing date;
a manufacturer lot;
an expiration date; or
a serial number.

15. A computing system, comprising:
one or more processors; and
one or more non-transitory computer-readable media that store instructions that, when executed by the one or more processors, cause the computing system to perform operations, the operations comprising:
obtaining one or more first images depicting removal of a first inventory item of a plurality of inventory items of a particular item type from an inventory storage area;
processing the one or more first images with one or more machine-learned computer vision models to generate one or more model outputs, wherein the one or more model outputs identify an item type for the inventory item, and wherein the one or more model outputs comprise values extracted from a label of the first inventory item;
identifying the first inventory item from the plurality of inventory items of the particular item type based on the values extracted from the label of the first inventory item; and
responsive to identifying the first inventory item, assigning a status to the first inventory item, wherein the status indicates that the first inventory item has been removed from the inventory storage area.

16. The computing system of claim 15, wherein the operations further comprise:
obtaining one or more second images depicting placement of the first inventory item on a surface;
obtaining one or more third images depicting removal of the first inventory item from the surface; and
based on the one or more third images, assigning a consumed status to the first inventory item, wherein the consumed status indicates that the first inventory item has been consumed.

17. The computing system of claim 16, wherein the surface comprises a surface of a mobile registration device comprising a camera device, and wherein the camera device is used to capture the one or more second images and the one or more third images.

18. The computing system of claim 17, wherein the one or more first images are captured using a separate camera device located within the inventory storage area.

19. The computing system of claim 15, wherein the operations further comprise:
obtaining one or more fourth images depicting the first inventory item being returned to the inventory storage area; and
based on the one or more fourth images, assigning an available status to the first inventory item indicating that the first inventory item is available at the inventory storage area.

20. One or more non-transitory computer-readable media that store instructions that, when executed by one or more processors, cause the one or more processors to perform operations, the operations comprising:
obtaining one or more first images depicting removal of a first inventory item of a plurality of inventory items of a particular item type from an inventory storage area;
processing the one or more first images with one or more machine-learned computer vision models to generate one or more model outputs, wherein the one or more model outputs identify an item type for the inventory item, and wherein the one or more model outputs comprise values extracted from a label of the first inventory item;
identifying the first inventory item from the plurality of inventory items of the particular item type based on the values extracted from the label of the first inventory item; and
responsive to identifying the first inventory item, assigning a status to the first inventory item, wherein the status indicates that the first inventory item has been removed from the inventory storage area.
